(19) United States
(12) Patent Application Publication
(10) Pub. No.: US 2004/0106073 A1
(43) Pub. Date: Jun. 3, 2004

(54) Forming method of resist pattern for improving accuracy of dimension of pattern, manufacturing method of semiconductor apparatus using the same and heat treatment apparatus for the same

(75) Inventor: Hiroshi Yoshino, Tokyo (JP)

Correspondence Address: Norman P. Soloway, HAYES SOLOWAY PC, 130 W. Cushing Street, Tucson, AZ, 85701, US

(73) Assignee: ELPIDA MEMORY INC.

(21) Appl. No.: 10/714,773

(22) Filed: Nov. 17, 2003

(30) Foreign Application Priority Data
Nov. 21, 2002 (JP) 338482/2002

(51) Int. Cl. A21B 1/22; F27D 11/00

(52) U.S. Cl. 430/330; 430/322; 430/323; 219/405; 219/402; 392/416

(57) ABSTRACT

A forming method of a resist pattern includes the following two steps. The first step is to carry out a heat treatment of a substrate, on which a resist pattern is formed, in a first heat treatment temperature in a first treatment period. The second step is to change said first heat treatment temperature to a second heat treatment temperature during said heat treatment such that a variation of dimensions of said resist pattern in said heat treatment reaches a desirable variation in a second treatment period.

### BACKGROUND OF THE INVENTION

1. Field of the Invention

The present invention relates to a forming method of resist pattern, a manufacturing method of a semiconductor apparatus and a heat treatment apparatus. Particularly, the present invention relates to a forming method of a resist pattern for improving accuracy of dimension of a pattern on a semiconductor substrate, a manufacturing method of a semiconductor apparatus using the same and a heat treatment apparatus for the same.

2. Description of the Related Art

In the semiconductor manufacturing field, to achieve high performance and high integration of a semiconductor, the design rule has been refined such as a miniaturization of a minimum line width. Therefore, in the lithography technology for forming a circuit pattern on a semiconductor substrate, it is required to improve a resolution of projection and accuracy of dimension of a resist pattern. Especially, in case of a contact hole for forming the electrical connection between layers in a semiconductor apparatus, a technique is proposed which reduces a diameter of an opening in a resist pattern of a contact hole as a forming method of a resist pattern for a contact hole that outsteps the resolution.

The techniques which reduce a diameter of an opening in a resist pattern of a contact hole are disclosed in Japanese Laid Open Patent Applications (JP Heisei 11-295904A, JP Heisei 11-119443A and JP Heisei 10-274854A). These techniques enable a shape of the contact hole to be controlled and made smaller by heating the resist pattern at a temperature equal to or more than a softening point of resist. Heating the resist pattern makes the diameter of the opening reduced gradually based on the plastic deformation of the resist pattern.

FIGS. 1A to 1D are cross sectional views of a main part of a substrate showing a process of a conventional forming method of a resist pattern (JP Heisei 11-295904A). Firstly, as shown in FIG. 1A, resist 111 is coated on a substrate 110. Then, the resist 111 is exposed by irradiating electron beams selectively to the resist 111 from an electron beam direct writing apparatus. Next, as shown in FIG. 1B, after a post exposure bake (PEB) is performed, resist holes 112 are formed by the resist 111 being developed. After that, as shown in FIG. 1C, the resist 111 reflows and is deformed by heat treatment. Finally, as shown in FIG. 1D, resist holes 112′ are formed, of which diameter is smaller than that of the resist holes 112 shown in FIG. 1B.

However, it is a problem in the above described process, which the dispersion of the dimensions of resist holes becomes wider than before, after the reduction of the resist hole size. The experiment performed by the inventor of the present invention shows that the dispersion of 0.02 μm was obtained in a 8-inches wafer in case that the diameter of the resist holes of 0.25 μm diameter is reduced to that of 0.20 μm. Here, the chemically amplified resist UV6 (manufactured by Shipley Far East Company) for KrF excimer laser exposure is used as the resist.

It is because the resist hole size strongly depends on the temperature of the reflow. The temperature dependence of reduction values of the resist hole size is approximately 0.02 μm/° C. in above-mentioned case. When the dispersion of 1° C. in a surface of a hot plate on which the reflow is performed, the dispersion of the reduction values would be 0.02 μm/° C.

Therefore, to suppress the dispersion of the reduction values, it is important to improve the uniformity of the temperature in the surface of the hot plate. Hence, Japanese Laid Open Patent Application (JP Heisei 9-190871, JP Heisei 11-8180) discloses the following baking heater controlled by a plurality of heating apparatus.

The heating apparatus disclosed in JP Heisei 9-190871 includes a heating body, a plurality of heaters, a plurality of temperature sensors and a control unit. The plurality of heaters is arranged in the heating body. Each of the plurality of temperature sensors detects a temperature of corresponding one of the plurality of heaters. The control unit section controls an operation of the plurality of heaters and an operation obtaining of the temperature data from the plurality of temperature sensors, in first division time and second division time obtained by dividing the first division time by integer, separately. Then, the control unit obtains the measuring result of the temperature sensor during at least one of the plurality of the second division time in one first division time, and calculates how many times of the second division time the heater is operated next the first division time during at least another one of the plurality of the second division time.

The baking apparatus disclosed in JP Heisei 11-8180 heats an objective film on a substrate by heater blocks on which the substrate is set. A temperature dispersion sensor is arranged above the film surface of the objective film, which detects temperature dispersion of the entire film surface. The apparatus controls the heating operation of the substrate by the heater blocks based on the temperature dispersion data from the temperature dispersion sensor. Each of the heater blocks may heat a corresponding area of the substrate independently each other.

In conjunction with the above description, Japanese Laid Open Patent Application (JP Heisei 10-55951) discloses the following a baking apparatus. The baking apparatus improves temperature dispersion property of a substrate by supplying heated inert gas on the substrate heated by a heater.

Japanese Laid Open Patent Application (JP 2002-64047) discloses the following a manufacturing method of a semiconductor apparatus and a semiconductor manufacturing apparatus. The manufacturing method of a semiconductor apparatus includes: forming a resist pattern on a substrate, forming a refined resist pattern by deforming a shape of the resist pattern, calculating a variation of the resist pattern by detecting a variation of film thickness of the resist or a variation of optical constant of the resist, and stopping the deformation of the resist pattern based on the variation.

When heat treatment of a wafer, on which a resist hole pattern (resist pattern of a contact hole) is formed, is carried out by using a hot plate, temperature of the hot plate before the heat treatment is at treatment temperature and in stable state. Next, when the wafer is set on the hot plate and the heat treatment is started, the temperature of the hot plate decreases temporarily. Then, the temperature control is carried out such that the temperature is recovered to the treatment temperature. Regarding the uniformity of the temperature in the hot plate surface in the stable state, it can be controlled with the dispersion of less than 0.5° C. by using a heat treatment apparatus that has a plurality of heater blocks as described above.

However, it is difficult to improve the uniformity of the temperature in the hot plate surface in the transient state. That causes the degradation of accuracy of dimension in the process in which the resist hole pattern is reduced by using the reflow method.

### SUMMARY OF THE INVENTION

Therefore, an object of the present invention is to provide a forming method of a resist pattern, a manufacturing method of a semiconductor apparatus and a heat treatment apparatus which improve the accuracy of dimension with respect to the amount of dimension reduction of the resist hole pattern (a resist pattern of a contact hole) on a semiconductor substrate, when a resist hole pattern is reduced by using reflow process.

Another object of the present invention is to provide a forming method of a resist pattern, a manufacturing method of a semiconductor apparatus and a heat treatment apparatus which improve the accuracy of dimension with respect to the contact hole on a semiconductor substrate, when the reduction process is used which the resist hole pattern is reduced by using reflow method.

In order to achieve an aspect of the present invention, the present invention provides a forming method of a resist pattern, comprising: (a) carrying out a heat treatment of a substrate, on which a resist pattern is formed, in a first heat treatment temperature in a first treatment period; and (b) changing said first heat treatment temperature to a second heat treatment temperature during said heat treatment such that a variation of dimensions of said resist pattern in said heat treatment reaches a desirable variation in a second treatment period.

In the forming method according to the present invention, said (b) comprises: (b1) calculating said second heat treatment temperature based on said desirable variation and said variation in said first heat treatment temperature; and (b2) carrying out said heat treatment of said substrate in said second heat treatment temperature in said second treatment period.

In the forming method according to the present invention, said (b1) comprises: (b11) calculating said variation based on a substantial temperature of said substrate, said first treatment period and a temperature dependence data which shows a relation between heat treatment temperatures and variation rates per unit of time of dimensions of said resist pattern.

In the forming method according to the present invention, said (b1) comprises: (b12) calculating said second heat treatment temperature based on a required variation which is a difference between said desirable variation and said variation in said first heat treatment temperature, said temperature dependence data and said second treatment period.

In the forming method according to the present invention, said (a) comprises: (a1) carrying out said heat treatment in said first heat treatment temperature in each of a plurality of areas in said substrate in said first treatment period independently. Said (b) comprises: (b3) changing said first heat treatment temperature to said second heat treatment temperature during said heat treatment such that said variation reaches said desirable variation in said second treatment period in said each of a plurality of areas.

In the forming method according to the present invention, said (b3) comprises: (b31) calculating said second heat treatment temperature based on said desirable variation and said variation in said first heat treatment temperature in said each of a plurality of areas; and (b32) carrying out said heat treatment of said substrate at said second heat treatment temperature in said second treatment period in said each of a plurality of areas.

In the forming method according to the present invention, said (b31) comprises: (b311) calculating said variation based on a substantial temperature of said substrate, said first treatment period and a temperature dependence data which shows a relation between heat treatment temperatures and variation rates per unit of time of dimensions of said resist pattern in said each of a plurality of said areas.

In the forming method according to the present invention, said (b31) comprises: (b312) calculating said second heat treatment temperature based on a required variation which is a difference between said desirable variation and said variation in said first heat treatment temperature, said temperature dependence data and said second treatment period in said each of a plurality of said areas.

In order to achieve another aspect of the present invention, the present invention provides a computer program product embodied on a computer-readable medium and comprising code that, when executed, causes a computer to perform the following: (a) carrying out a heat treatment of a substrate, on which a resist pattern is formed, in a first heat treatment temperature in a first treatment period; and (b) changing said first heat treatment temperature to a second heat treatment temperature during said heat treatment such that a variation of dimensions of said resist pattern in said heat treatment reaches a desirable variation in a second treatment period.

In the computer program product according to the present invention said (b) comprises: (b1) calculating said second heat treatment temperature based on said desirable variation and said variation in said first heat treatment temperature; and (b2) carrying out said heat treatment of said substrate in said second heat treatment temperature in said second treatment period.

In the computer program product according to the present invention, wherein said (b1) comprises: (b11) calculating said variation based on a substantial temperature of said substrate, said first treatment period and a temperature dependence data which shows a relation between heat treatment temperatures and variation rates per unit of time of dimensions of said resist pattern.

In the computer program product according to the present invention, said (b1) comprises: (b12) calculating said second heat treatment temperature based on a required variation which is a difference between said desirable variation and said variation in said first heat treatment temperature, said temperature dependence data and said second treatment period.

In the computer program product according to the present invention, said (a) comprises: (a1) carrying out said heat treatment in said first heat treatment temperature in each of a plurality of areas in said substrate in said first treatment period independently. Said (b) comprises: (b3) changing said first heat treatment temperature to said second heat treatment temperature during said heat treatment such that said variation reaches said desirable variation in said second treatment period in said each of a plurality of areas.

In the computer program product according to the present invention, said (b3) comprises: (b31) calculating said second heat treatment temperature based on said desirable variation and said variation in said first heat treatment temperature in said each of a plurality of areas; and (b32) carrying out said heat treatment of said substrate at said second heat treatment temperature in said second treatment period in said each of a plurality of areas.

In the computer program product according to the present invention, said (b31) comprises: (b311) calculating said variation based on a substantial temperature of said substrate, said first treatment period and a temperature dependence data which shows a relation between heat treatment temperatures and variation rates per unit of time of dimensions of said resist pattern in said each of a plurality of said areas.

In the computer program product according to the present invention, said (b31) comprises: (b312) calculating said second heat treatment temperature based on a required variation which is a difference between said desirable variation and said variation in said first heat treatment temperature, said temperature dependence data and said second treatment period in said each of a plurality of said areas.

In order to achieve still another aspect of the present invention, the present invention provides a heat treatment apparatus comprising: a plurality of heat treatment sections, a plurality of temperature sensors and a control section. The each of plurality of heat treatment sections separately carries out a heat treatment of corresponding one of a plurality of areas in a substrate having a resist pattern. The each of plurality of temperature sensors detects a temperature of corresponding one of said plurality of heat treatment sections. The control section controls each of said plurality of heat treatment sections based on corresponding one of each of detection results. Said control section calculates a variation of dimensions of said resist pattern in said heat treatment in a first heat treatment temperature in a first treatment period based on said first heat treatment temperature, and changes said first heat treatment temperature to a second heat treatment temperature such that said variation reaches a desirable variation in said each of a plurality of areas in a second treatment period, during said heat treatment.

In the heat treatment apparatus according to the present invention, said control section calculates said second heat treatment temperature based on said desirable variation and said variation in said first heat treatment temperature in said first treatment period in said each of a plurality of said areas, and carries out said heat treatment of said substrate in said second heat treatment temperature in said second treatment period in said each of a plurality of said areas.

In the heat treatment apparatus according to the present invention, said control section calculates said variation based on a temperature at a place beside said substrate, said first treatment period and a temperature dependence data which shows a relation between heat treatment temperatures and variation rates per unit of time of dimensions of said resist pattern in said each of a plurality of said areas.

In the heat treatment apparatus according to the present invention, wherein said control section calculates said second heat treatment temperature based on a required variation which is a difference between said desirable variation and said variation in said first heat treatment temperature, said temperature dependence data and said second treatment period in said each of a plurality of said areas.

In order to achieve yet still another aspect of the present invention, the present invention provides a manufacturing method of a semiconductor apparatus, comprising: (c) forming a resist pattern on a substrate on which a film is formed; (d) carrying out a heat treatment of said substrate in a first heat treatment temperature in a first treatment period; (e) changing said first heat treatment temperature to a second heat treatment temperature during said heat treatment such that a variation of dimensions of said resist pattern in said heat treatment reaches a desirable variation in a second treatment period; (f) etching said film on said substrate; and (g) removing said resist pattern from said substrate.

In the manufacturing method according to the present invention, said (e) comprises: (e1) calculating said second heat treatment temperature based on said desirable variation and said variation in said first heat treatment temperature; and (e2) carrying out said heat treatment of said substrate in said second heat treatment temperature in said second treatment period.

In the manufacturing method according to the present invention, said (e1) comprises: (e11) calculating said variation based on a substantial temperature of said substrate, said first treatment period and a temperature dependence data which shows a relation between heat treatment temperatures and variation rates per unit of time of dimensions of said resist pattern.

The manufacturing method according to the present invention, said (e1) comprises: (e12) calculating said second heat treatment temperature based on a required variation which is a difference between said desirable variation and said variation in said first heat treatment temperature, said temperature dependence data and said second treatment period.

### BRIEF DESCRIPTION OF THE DRAWINGS

FIGS. 1A to 1D are cross sectional views of a main part of a substrate showing a process of a conventional forming method of a resist pattern;

FIG. 2 is a block diagram showing the configuration of the embodiment of the heat treatment apparatus according to the present invention;

FIG. 3 is a graph showing the change of the heat treatment temperature based on elapsed time of the embodiment of the forming method of resist pattern according to the present invention;

FIG. 4 is a view showing a flowchart for a temperature control of the embodiment of the forming method of resist pattern according to the present invention;

FIG. 5 is a graph showing the relation between the diameter of the resist hole pattern and the heat treatment time in case that the heat treatment temperature is constant;

FIG. 6 is a graph showing the relation between the diameter of the resist hole pattern and the heat treatment temperature in case that the heat treatment time is constant; and

FIG. 7 is a view showing a flowchart of the embodiment of the manufacturing method of a semiconductor apparatus according to the present invention.

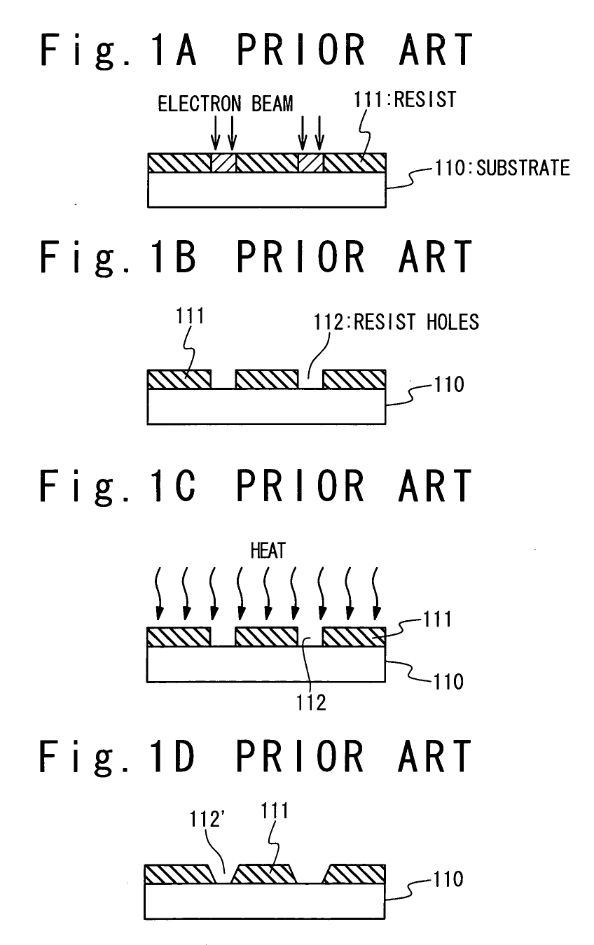

### DESCRIPTION OF THE PREFERRED EMBODIMENTS

Embodiments of a forming method of resist pattern, a manufacturing method of a semiconductor apparatus and a heat treatment apparatus according to the present invention will be described below with reference to the attached drawings.

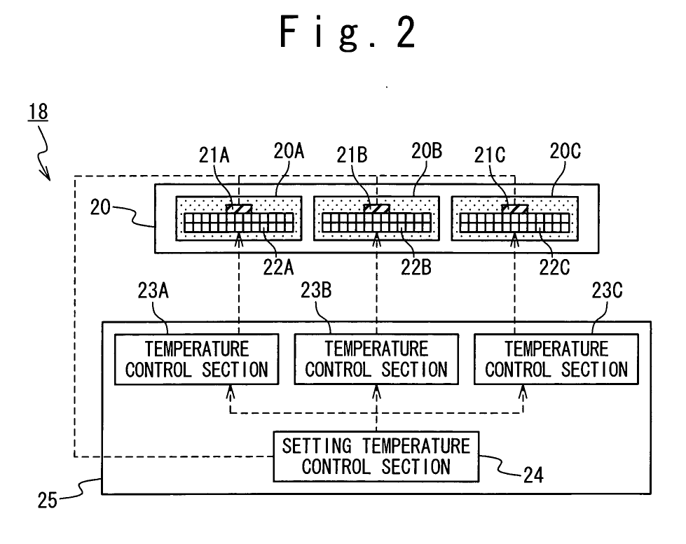

FIG. 2 is a block diagram showing the configuration of the embodiment of the heat treatment apparatus according to the present invention. The heat treatment apparatus includes a hot plate 20 and a control section 25.

The hot plate 20 includes heater blocks 20A, 20B and 20C, which heat the hot plate 20. Each of the heater blocks 20A, 20B and 20C covers a corresponding area in the hot plate 20. Each of them includes a heater 22A and a temperature sensor 21A, a heater 22B and a temperature sensor 21B, and a heater 22C and a temperature sensor 21C, respectively. Each of the temperature sensors 21A, 21B and 21C measures the surface of the corresponding one of the heater blocks 20A, 20B and 20C, where the substrate is very close. Therefore, the temperatures measured by the temperature sensors 21A, 21B and 21C is substantially equal to the substrate temperature. Here, the “substantially equal to the substrate temperature” means that the measured temperature can be used as the substrate temperature for controlling of the heat treatment.

The control section 25 includes a setting temperature control section 24, a temperature control sections 23A, 23B and 23C. The setting temperature control section 24 sets a setting temperature, which is preset or determined based on temperatures measured by the temperature sensor 21A, 21B and 21C. The setting temperature control section 24 outputs the setting temperature to the temperature control sections 23A, 23B and 23C. The temperature control sections 23A, 23B and 23C are independent to each other. Each of them controls the corresponding one of the heater 22A, 22B and 22C such that the corresponding one of the heater blocks 20A, 20B and 20C is in the setting temperature.

On the hot plate 20 (the heater block 20A, 20B and 20C), a semiconductor substrate (a wafer) is provided and set on which a resist pattern is formed. Then, the substrate is heated by the heater blocks 20A, 20B and 20C. The uniformity of the temperature is maintained in the surface of the hot plate 20 by controlling the plurality of the heater block independently.

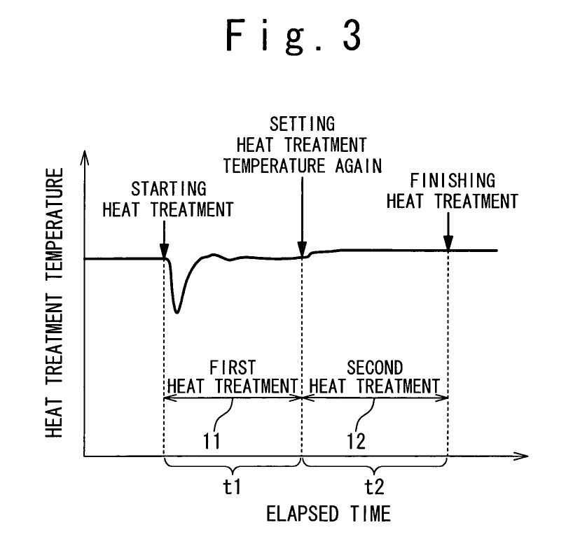

Next, the embodiment of a forming method of resist pattern according to the present invention will be described below. FIG. 3 is a graph showing the change of the heat treatment temperature based on elapsed time of the embodiment of the forming method of resist pattern according to the present invention. The vertical axis shows the heat treatment temperature, the horizontal axis shows the elapsed time. The heat treatment of this embodiment includes a first heat treatment 11 and a second heat treatment 12 following the first heat treatment 11. The first heat treatment 11 is carried out in a first heat treatment temperature, which is initially set. The second heat treatment 12 is carried out in a second heat treatment temperature, to which the first heat treatment temperature is changed based on the state of the first heat treatment 11. Here, the first heat treatment 11 and the second heat treatment 12 are carried out continuously. A heat treatment time t1of the first heat-treatment 11 and a heat treatment time t2 of the second heat-treatment 12 are initially set.

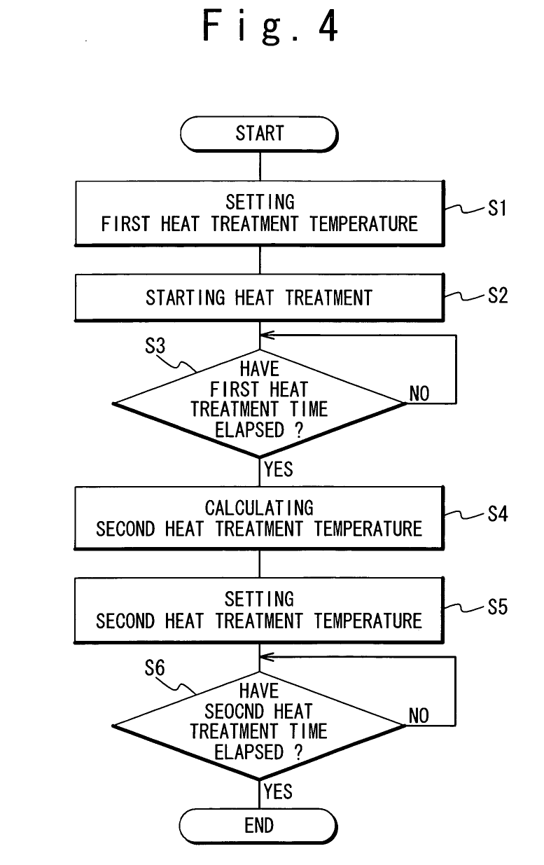

FIG. 4 is a view showing a flowchart for a temperature control of the embodiment of the forming method of resist pattern according to the present invention. The heat treatment method of the heater block 20A, 20B and 20C will be described below with reference to FIG. 4.

Firstly, the temperature of the heat treatment apparatus 18 is set to the first heat treatment temperature which is the setting temperature of the first heat treatment 11, before the heat treatment of the substrate (the semiconductor substrate on which the certain film is formed) is carried out (step S1). Here, the setting temperature control section 24 outputs the first heat treatment temperature to the temperature control sections 23A, 23B and 23C as the initial setting temperature. Each of the temperature control sections 23A, 23B and 23C controls the corresponding one of the heater 22A, 22B and 22C such that the corresponding one of the heater blocks 20A, 20B and 20C becomes in the first heat treatment temperature. As a result, the heater blocks 20A, 20B and 20C becomes in the setting temperature (the first heat treatment temperature) of the first heat treatment 11.

After the setting is finished, the substrate on which the resist pattern is formed is introduced on the hot plate 20, and the heat treatment is started (step S2: “starting the heat treatment” shown in FIG. 3). When the heat treatment is started, the temperature of the heat treatment apparatus 18 is decreasing temporally as shown in FIG. 3 because the lower temperature substrate is introduced. However, after that, the temperature control by the control section 25 makes the temperature increase to the setting temperature of the first heat treatment 11 again. Here, each of the temperature control sections 23A, 23B and 23C receives the temperature measured by the corresponding one of the temperature sensors 21A, 21B and 21C. Then, each of them controls the controls the corresponding one of the heater 22A, 22B and 22C such that the corresponding one of the heater blocks 20A, 20B and 20C becomes in the first heat treatment temperature, based on the temperature measuring results. The controlling method is exemplified in PID (proportional integral differential) control. The data of the temperature measuring results measured by the temperature sensors 21A, 21B and 21C are stored in a memory section (not shown) of the setting temperature control section 24 with the data measuring (receiving) time.

When the preset first heat treatment time t1 passes (elapses) (step S3, YES), the setting temperature control section 24 calculates a variation of dimensions of the resist pattern in the first heat treatment time t1, based on the temperature at a place beside the substrate, the first heat treatment time t1 and a temperature dependence data. Here, the temperature at a place beside the substrate is the data of the temperature measuring results measured by the temperature sensors 21A, 21B and 21C. The temperature dependence data shows a relation between heat treatment temperatures and variation rates per unit of time of dimensions of the resist pattern. The temperature and the temperature dependence data are stored in the memory section (not shown) of the setting temperature control section 24. Then, the setting temperature control section 24 calculates a required variation in the second heat treatment 12, which is a difference between the variation of dimensions of the resist pattern and a desirable variation of dimensions of the resist pattern. The desirable variation is the target variation that should be achieved during heat treatment times t1 and t2. It is predetermined and stored in the memory section (not shown) of the setting temperature control section 24. After that, the setting temperature control section 24 calculates the second heat treatment temperature in the second heat treatment 12 based on the required variation, the temperature dependence data and the second heat treatment time t2 (stet S4).

Next, the temperature of the heat treatment apparatus 18 is set to the second heat treatment temperature which is the setting temperature of the. second heat treatment 12 (step S5: “setting the heat treatment temperature again” shown in FIG. 3). Here, the setting temperature control section 24 outputs the second heat treatment temperature to the temperature control sections 23A, 23B and 23C as the changed setting temperature. Each of the temperature control sections 23A, 23B and 23C controls the corresponding one of the heater 22A, 22B and 22C such that the corresponding one of the heater blocks 20A, 20B and 20C becomes in the second heat treatment temperature. As a result, the heater blocks 20A, 20B and 20C becomes in the changed setting temperature (the second heat treatment temperature) of the second heat treatment 12.

Next, the second heat treatment 12 is carried out in the second heat treatment time t2 to the substrate (step S6). After the second heat treatment time t2 passes and the second heat treatment 12 is finished (“finishing the heat treatment” shown in FIG. 3), the substrate is taken out from the heat treatment apparatus 18 and the entire heat treatment is finished.

Next, the embodiment of the forming method of the resist pattern according to the present invention will be described in detail.

At first, the chemically amplified resist UV6 (manufactured by Shipley Far East Company) for KrF excimer laser exposure is coated on a semiconductor such as silicon substrate by a spin coat method. Then, the substrate is heated at the temperature of 130° C. for 1 minute. As a result, the resist pattern with the thickness of 0.7 μm is formed on the substrate. Next, after being exposed by the KrF excimer laser through the mask for the exposure, the resist pattern is baked at the temperature of 140° C. for 1 minute as a post bake. After that, the resist pattern is developed by an aqueous solution with 2.38% by weight of the tetramethylammonium. Then, the resist hole pattern with the diameter of 0.25 μm is formed in the resist pattern.

Next, the temperature of the heat treatment apparatus 18 is set to 156° C. (step S1). In the heat treatment apparatus 18, the hot plate 20 includes three separate blocks of the heater block 20A, 20B and 20C. Then, the substrate, on which the resist hole pattern is formed, is introduced on the hot plate 20 of the heat treatment apparatus 18 (step S2). After that, the first heat treatment 11 is carried out in the first heat treatment time t1 of 60 sec. (step S3). The temperature T of each heater blocks 20A, 20B and 20C is measured by the corresponding one of the temperature sensor 21A, 21B and 21C.

Here, the amount of the reduction of the diameter of the resist hole pattern ΔCD1 (the variation of dimensions of the resist pattern) in the first heat treatment 11 is calculated by the equation (1)shown below based on the temperature T, the first heat treatment time t1 and the temperature dependence data NCD(T). The temperature dependence data NCD(T) shows a relation between heat treatment temperatures (T) and the reduction amount rate per unit of time for the diameter of the resist hole pattern, which are made preparations in advance.

$$Δ CD1 = {\int }_{t = 0}^{60} NCD ( T ( t ) ) ⅆ t \qquad ( 1 )$$

In this equation (1), the t shows the heat treatment time (sec.). In this case, t was from 0 to 60 sec, which is “t1” shown in FIG. 3.

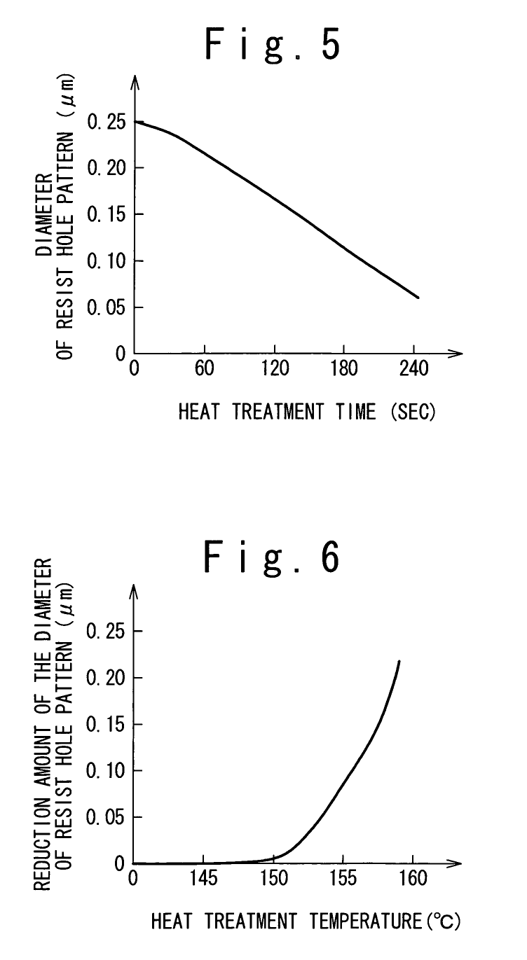

As for the reduction amount rate per unit of time for the diameter of the resist hole pattern, in case that the heat treatment temperature is constant, the diameter of the resist hole pattern is linearly reduced during the heat treatment. The situation is shown in FIG. 5. FIG. 5 is a graph showing the relation between the diameter of the resist hole pattern and the heat treatment time in case that the heat treatment temperature is constant. The vertical axis shows the diameter of the resist hole pattern. The horizontal axis shows the heat treatment time. As shown in FIG. 5, the NCD(T0) of the heat treatment temperature T0 approximates the value dividing the reduction amount of the diameter of the resist pattern in the heat treatment time of 120 sec. simply by the heat treatment time of 120 sec.

FIG. 6 is a graph showing the relation between the reduction amount of the diameter of the resist hole pattern and the heat treatment temperature in case that the heat treatment time is constant. The vertical axis shows the reduction amount of the diameter of the resist hole pattern. The horizontal axis shows the heat treatment temperature. These data can be obtained, for example, by the experiment regarding the relation of reduction amount of the diameter of the resist hole pattern when the heat treatment temperature is changed in the heat treatment time of 120 sec. The temperature dependence data showing the relation between heat treatment temperatures and variation rates per unit of time of dimensions of the resist pattern are, for example, the data shown in FIG. 6. The setting temperature control section 24 stores the temperature dependence data of a plurality of kinds of heat treatment times in its memory (not shown).

Next, a required amount of the reduction of the diameter of the resist hole pattern ΔCD2 (a required variation of dimensions of the resist pattern) in the second heat treatment 12 is calculated by using a following equation (2) based on a desirable amount of the reduction of the diameter of the resist hole pattern ΔCDT (the desirable variation of dimensions of the resist pattern) and the desirable amount of the reduction of the diameter of the resist hole pattern ΔCD1 of the first heat treatment 11.

ΔCD2=ΔCDT−ΔCD1 (2)

Here, the ΔCDT is set to 0.1 μm. The second heat treatment temperature T2 is calculated which satisfies a following equation (3) based on the required variation ΔCD2, the temperature dependence data shown in FIG. 6 and the second heat treatment time t2 (stet S4). Here, the t2 is set to 60 sec.

NCD(T2)=ΔCD2/t2 (3)

After the setting temperature for the second heat treatment 12 in each one of the heater blocks 20A, 20B and 20C is calculated as described above, the setting temperature of the second heat treatment 12 of the heat treatment apparatus 18 is changed to the calculated value (step S5: “setting the heat treatment temperature again” shown in FIG. 3). Then, the second heat treatment 12 is carried out in 60 sec (step S6). As a result, the diameter of the resist hole pattern is reduced of which variation is approximately 0.1 μm, and the resist hole patterns can be obtained, of which the diameters are 0.15 μm with an error span of ±0.06 μm in entire surface of the wafer (substrate).

On the other hand, when the heat treatment of the resist hole pattern is carried out simply at 156° C. in 120 sec., the diameters of the resist hole patterns are 0.15 μm with an error span of±0.10 μm in entire surface of the wafer.

That is, according to the forming method of the resist pattern of the present invention, the accuracy of dimension can be improved in the reduction amount of the hole dimensions of the resist hole pattern and the hole dimensions can be controlled more precisely.

In the above embodiment, the resist for KrF excimer laser exposure is used. However, other kinds of resists, which is deformed by the heat treatment, can be used such as a conventional resist for i-line and g-line exposure containing naphthoquinone diazide series photoresist/novolac-type resins, a resist for ArF excimer laser exposure, a resist for F2 excimer laser exposure, a resist for electron beam exposure and a resist for extreme-ultraviolet radiation exposure.

Also, in the above embodiment, the heat treatment apparatus 18 includes three heater blocks 20A, 20B and 20C. However, The number of the heater blocks is not limited to three.

Also, in the above embodiment, the heat treatment process includes two heat treatments 11 and 12. However, The number of the heater treatment is not limited to two.

Also, in the above embodiment, the temperature sensors 21A, 21B and 21C are used for the heat treatment, each of which is in the corresponding one of the heater blocks 20A, 20B and 20C. However, another temperature sensor such as infrared radiation temperature sensor can be used for the heat treatment, which can measure the substrate temperature.

Also, in the above embodiment, the resist hole pattern is described. However, the present invention can be applied for another resist pattern such as a resist pattern for forming a trench of wiring.

The forming method of a resist pattern and the heat treatment apparatus can control the variation of the dimensions of the resist pattern to be the desirable variation in the heat treatment. Therefore, the reproducibility of the variation of the dimensions of the resist pattern can be improved in the heat treatment for a plurality of substrates. Hence, the accuracy of dimension of the resist pattern can be improved.

Further, the forming method of a resist pattern and the heat treatment apparatus can control the variation of the resist pattern on each heater blocks separately. Therefore, the uniformity of the variation in the surface of the substrate can be improved.

Furthermore, using the substrate temperature instead of that of the heater blocks makes the accuracy of the variation be improved further.

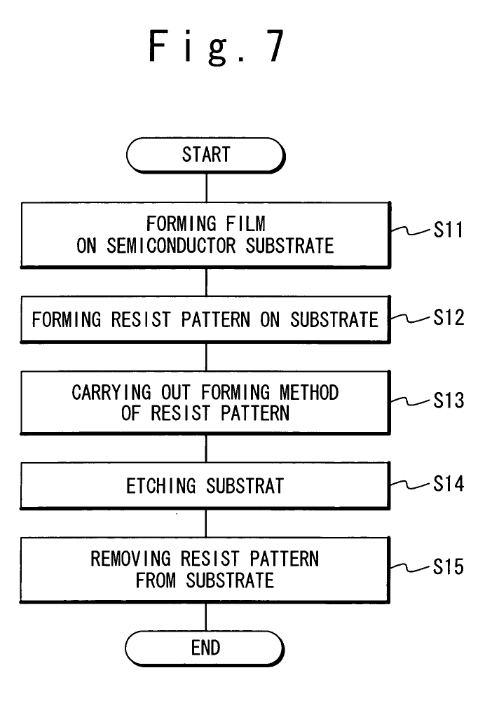

Next, the embodiment of the manufacturing method of a semiconductor apparatus according to the present invention will be described with reference to FIG. 7. FIG. 7 is a view showing a flowchart of the embodiment of the manufacturing method of a semiconductor apparatus according to the present invention. In this embodiment, the above-described forming method of the resist pattern is applied to the manufacturing method of a semiconductor.

Firstly, a film is formed on a semiconductor substrate (step S11). Next, a resist pattern is formed on the substrate by using a photolithography technique (step S12). Then, the forming method of the resist pattern is carried out to the substrate, which includes the above-described processes of steps S1 to S6 (step S13). After the desirable resist pattern is formed, the etching process is carried out to the substrate (step S14). Then, the resist pattern is removed from the substrate (step S15). By continuing this film forming process, the resist pattern forming process and the film etching process, the semiconductor apparatus is manufactured.

Because this semiconductor apparatus is manufactured by using the above forming method of the resist pattern, the accuracy of the dimensions of the pattern can be improved. Therefore, the reliability and reproducibility of the semiconductor apparatus can be improved.

What is claimed is:

1. A forming method of a resist pattern, comprising:
(a) carrying out a heat treatment of a substrate, on which a resist pattern is formed, in a first heat treatment temperature in a first treatment period; and
(b) changing said first heat treatment temperature to a second heat treatment temperature during said heat treatment such that a variation of dimensions of said resist pattern in said heat treatment reaches a desirable variation in a second treatment period.

2. The forming method according to claim 1, wherein said (b) comprises:
(b1) calculating said second heat treatment temperature based on said desirable variation and said variation in said first heat treatment temperature; and
(b2) carrying out said heat treatment of said substrate in said second heat treatment temperature in said second treatment period.

3. The forming method according to claim 2, wherein said (b1) comprises:
(b11) calculating said variation based on a substantial temperature of said substrate, said first treatment period and a temperature dependence data which shows a relation between heat treatment temperatures and variation rates per unit of time of dimensions of said resist pattern.

4. The forming method according to claim 3, wherein said (b1) comprises:
(b12) calculating said second heat treatment temperature based on a required variation which is a 5 difference between said desirable variation and said variation in said first heat treatment temperature, said temperature dependence data and said second treatment period.

5. The forming method according to claim 1, wherein said (a) comprises:
(a1) carrying out said heat treatment in said first heat treatment temperature in each of a plurality of areas in said substrate in said first treatment period independently, said (b) comprises:
(b3) changing said first heat treatment temperature to said second heat treatment temperature during said heat treatment such that said variation reaches said desirable variation in said second treatment period in said each of a plurality of areas.

6. The forming method according to claim 5, wherein said (b3) comprises:
(b31) calculating said second heat treatment temperature based on said desirable variation and said variation in said first heat treatment temperature in said each of a plurality of areas; and
(b32) carrying out said heat treatment of said substrate at said second heat treatment temperature in said second treatment period in said each of a plurality of areas.

7. The forming method according to claim 6, wherein said (b31) comprises:
(b311) calculating said variation based on a substantial temperature of said substrate, said first treatment period and a temperature dependence data which shows a relation between heat treatment temperatures and variation rates per unit of time of dimensions of said resist pattern in said each of a plurality of said areas.

8. The forming method according to claim 7, wherein said (b31) comprises:
(b312) calculating said second heat treatment temperature based on a required variation which is a difference between said desirable variation and said variation in said first heat treatment temperature, said temperature dependence data and said second treatment period in said each of a plurality of said areas.

9. A computer program product embodied on a computer-readable medium and comprising code that, when executed, causes a computer to perform the following:
(a) carrying out a heat treatment of a substrate, on which a resist pattern is formed, in a first heat treatment temperature in a first treatment period; and
(b) changing said first heat treatment temperature to a second heat treatment temperature during said heat treatment such that a variation of dimensions of said resist pattern in said heat treatment reaches a desirable variation in a second treatment period.

10. The computer program product according to claim 9, wherein said (b) comprises:
(b1) calculating said second heat treatment temperature based on said desirable variation and said variation in said first heat treatment temperature; and
(b2) carrying out said heat treatment of said substrate in said second heat treatment temperature in said second treatment period.

11. The computer program product according to claim 10, wherein said (b1) comprises:
(b11) calculating said variation based on a substantial temperature of said substrate, said first treatment period and a temperature dependence data which shows a relation between heat treatment temperatures and variation rates per unit of time of dimensions of said resist pattern.

12. The computer program product according to claim 11, wherein said (b1) comprises:
(b12) calculating said second heat treatment temperature based on a required variation which is a difference between said desirable variation and said variation in said first heat treatment temperature, said temperature dependence data and said second treatment period.

13. The computer program product according to claim 9, wherein said (a) comprises:
(a1) carrying out said heat treatment in said first heat treatment temperature in each of a plurality of areas in said substrate in said first treatment period independently, said (b) comprises:
(b3) changing said first heat treatment temperature to said second heat treatment temperature during said heat treatment such that said variation reaches said desirable variation in said second treatment period in said each of a plurality of areas.

14. The computer program product according to claim 13, wherein said (b3) comprises:
(b31) calculating said second heat treatment temperature based on said desirable variation and said variation in said first heat treatment temperature in said each of a plurality of areas; and
(b32) carrying out said heat treatment of said substrate at said second heat treatment temperature in said second treatment period in said each of a plurality of areas.

15. The computer program product according to claim 14, wherein said (b31) comprises:
(b311) calculating said variation based on a substantial temperature of said substrate, said first treatment period and a temperature dependence data which shows a relation between heat treatment temperatures and variation rates per unit of time of dimensions of said resist pattern in said each of a plurality of said areas.

16. The computer program product according to claim 15, wherein said (b31) comprises:
(b312) calculating said second heat treatment temperature based on a required variation which is a difference between said desirable variation and said variation in said first heat treatment temperature, said temperature dependence data and said second treatment period in said each of a plurality of said areas

17. A heat treatment apparatus comprising:
a plurality of heat treatment sections each of which separately carries out a heat treatment of corresponding one of a plurality of areas in a substrate having a resist pattern;
a plurality of temperature sensors each of which detects a temperature of corresponding one of said plurality of heat treatment sections; and
a control section which controls each of said plurality of heat treatment sections based on corresponding one of each of detection results,
wherein said control section calculates a variation of dimensions of said resist pattern in said heat treatment in a first heat treatment temperature in a first treatment period based on said first heat treatment temperature, and changes said first heat treatment temperature to a second heat treatment temperature such that said variation reaches a desirable variation in said each of a plurality of areas in a second treatment period, during said heat treatment.

18. The heat treatment apparatus according to claim 17, wherein said control section calculates said second heat treatment temperature based on said desirable variation and said variation in said first heat treatment temperature in said first treatment period in said each of a plurality of said areas, and carries out said heat treatment of said substrate in said second heat treatment temperature in said second treatment period in said each of a plurality of said areas.

19. The heat treatment apparatus according to claim 18, wherein said control section calculates said variation based on a temperature at a place beside said substrate, said first treatment period and a temperature dependence data which shows a relation between heat treatment temperatures and variation rates per unit of time of dimensions of said resist pattern in said each of a plurality of said areas.

20. The heat treatment apparatus according to claim 19, wherein said control section calculates said second heat treatment temperature based on a required variation which is a difference between said desirable variation and said variation in said first heat treatment temperature, said temperature dependence data and said second treatment period in said each of a plurality of said areas.

21. A manufacturing method of a semiconductor apparatus, comprising:
(c) forming a resist pattern on a substrate on which a film is formed;
(d) carrying out a heat treatment of said substrate in a first heat treatment temperature in a first treatment period;
(e) changing said first heat treatment temperature to a second heat treatment temperature during said heat treatment such that a variation of dimensions of said resist pattern in said heat treatment reaches a desirable variation in a second treatment period;
(f) etching said film on said substrate; and
(g) removing said resist pattern from said substrate.

22. The manufacturing method according to claim 21, wherein said (e) comprises:
(e1) calculating said second heat treatment temperature based on said desirable variation and said variation in said first heat treatment temperature; and
(e2) carrying out said heat treatment of said substrate in said second heat treatment temperature in said second treatment period.

23. The manufacturing method according to claim 22, wherein said (e1) comprises:
(e11) calculating said variation based on a substantial temperature of said substrate, said first treatment period and a temperature dependence data which shows a relation between heat treatment temperatures and variation rates per unit of time of dimensions of said resist pattern.

24. The manufacturing method according to claim 23, wherein said (e1) comprises:
(e12) calculating said second heat treatment temperature based on a required variation which is a difference between said desirable variation and said variation in said first heat treatment temperature, said temperature dependence data and said second treatment period.
